(19) United States
(12) Patent Application Publication
(10) Pub. No.: US 2006/0025078 A1
(43) Pub. Date: Feb. 2, 2006

(54) Remote push to talk actuator for handgun or other portable equipment

(76) Inventors: Kevin S. Sinha, Athens, GA (US); John W. Oglesbee, Watkinsville, GA (US)

Correspondence Address: MOTOROLA INC, 600 NORTH US HIGHWAY 45, ROOM AS437, LIBERTYVILLE, IL, 60048-5343, US

(21) Appl. No.: 10/899,548

(22) Filed: Jul. 27, 2004

(51) Int. Cl. H04B 1/38

(52) U.S. Cl. 455/66.1; 455/90.3

(57) ABSTRACT

A hand tool, like a handgun, is provided having a wireless, push to talk switch embedded therein. When the push to talk switch is actuated, a signal is sent to an external, nearby two-way communication device. The signal is capable of actuating the microphone of the two-way communication device and causing transmission. In so doing, a user may use the communication device while keeping two hands on the tool. For example, when a police officer has two hands on a firearm, the police officer may press the push to talk button on the firearm, thereby allowing him to call for assistance with a radio or mobile telephone without having to take his hands off the firearm.

### BACKGROUND

1. Technical Field

This invention relates generally to a portable tool that includes radio frequency electronics, and more specifically to a hand tool having wireless communication capabilities for actuating an external communication device.

2. Background Art

Since the terrible events of Sep. 11, 2001, the world seems to be a scarier place. The Department of Homeland Security (DHS) continually updates an Advisory System that notifies the citizenry of the threat of a terrorist attack in the United States. Emergency personnel are continually on alert. Increased safety measures are being put into effect everywhere from schools to sporting events. As the DHS states on its website, “We remain a nation at risk to terrorist attacks and will remain at risk for the foreseeable future.”

No one knows this more that the policeman on the beat. Not only are our county, city and state law enforcement officers placing their lives on the line every day to thwart domestic criminals, they are now being asked to defend us against foreign enemies as well. The job demanded of our brave police force is becoming ever more difficult.

In this day and age, timely communication has become increasingly important to the police department. When the policeman on patrol encounters a problem, be it either a simple domestic crime or a coordinated terrorist attack, it is imperative that he communicate with both the central precinct and other officers as soon as possible. Traditionally, this communication occurs via two-way radios. When the officer needs to talk to others, he simply takes his trusty two-way radio off of his belt, presses a button to talk, and relays his message.

The need to manually handle a radio to communicate becomes problematic, however, when the officer has his weapon drawn. As shown in FIG. 1, a law enforcement officer is taught to bear his sidearm 2 with two hands 3,4. For the right handed officer 1, when the firearm 2 is drawn, the right hand 3 is placed upon the grip of the gun 2, while the left hand 4 is placed under the right 3. In this position, the right hand 3 can pull the trigger and resist recoil, while the left hand offers stabilization for aiming. Aiming stability is critical because an errantly discharged bullet can have harmful effects. For this reason, policemen always use two hands when handling a firearm.

When the officer is in this “two-handed” firearm handling position, it is impossible for him to “key” his radio to call, for example, for back-up assistance. Additionally, certain situations require officers to hold both a flashlight and pistol simultaneously. Since both hands are occupied in these situations, there is no free hand to depress the “talk” key on the radio. Not surprisingly, the times at which the officer's gun is drawn tend to be the times the officer most needs to communicate with others, especially when back-up assistance is required.

One prior art solution to this problem is taught in U.S. Pat. No. 4,996,787, entitled “SigSauer Pistol with Concealed Radio Transmitter”, issued to Holcomb et al. This patent teaches placing a complete radio in the grip of the gun. The radio includes a pair of ⅔ AA batteries, springs to hold the batteries in, complete radio circuitry, power amplifiers and an antenna.

The problem with this prior art solution is twofold: First, embedding a complete radio transmitter in the grip of the gun reduces the amount of space that could be storing ammunition. One of the primary reasons that most police forces switched from the old Smith and Wesson® revolver to the 0.40 caliber Glock® pistol is ammunition capacity. While the S&W® revolver held 6 bullets, the Glock® can hold as many as 16 in a single clip. Add one in the chamber and the Glock® has a 17 round capacity. With criminals, like drug dealers for instance, using high powered weapons, the police needed more firepower. Embedding a complete radio transmitter in the grip of a gun cuts the ammunition capacity by more than 50%, rendering such a solution unworkable.

The second problem is that the police officer may need to communicate when firing the gun. When the complete radio transmitter is embedded in the handle, the microphone and electronics are disposed directly adjacent to the firing chamber and barrel. Not only will the large amounts of thermal and acoustic energy damage the microphone when the gun is being fired, but the sound pressure level of a 0.40 caliber bullet exploding adjacent to the microphone will all but guarantee that the party with whom the officer is attempting to communicate will be completely unable to hear the officer's words.

There is thus a need for an improved communication system that can be actuated by a person while using a hand tool that requires two-hand operation.

### BRIEF DESCRIPTION OF THE DRAWINGS

FIG. 1 illustrates a person shooting a firearm.

FIGS. 2 and 3 illustrated front and rear views, respectively, of a police officer wearing standard-issue equipment.

FIG. 4 illustrates a hand tool and system in accordance with the invention.

FIG. 5 illustrates one embodiment of a wireless switch in accordance with the invention.

FIGS. 6 and 7 illustrate alternate embodiments of a wireless switch in accordance with the invention.

FIG. 8 illustrates one preferred energy saving embodiment of the invention.

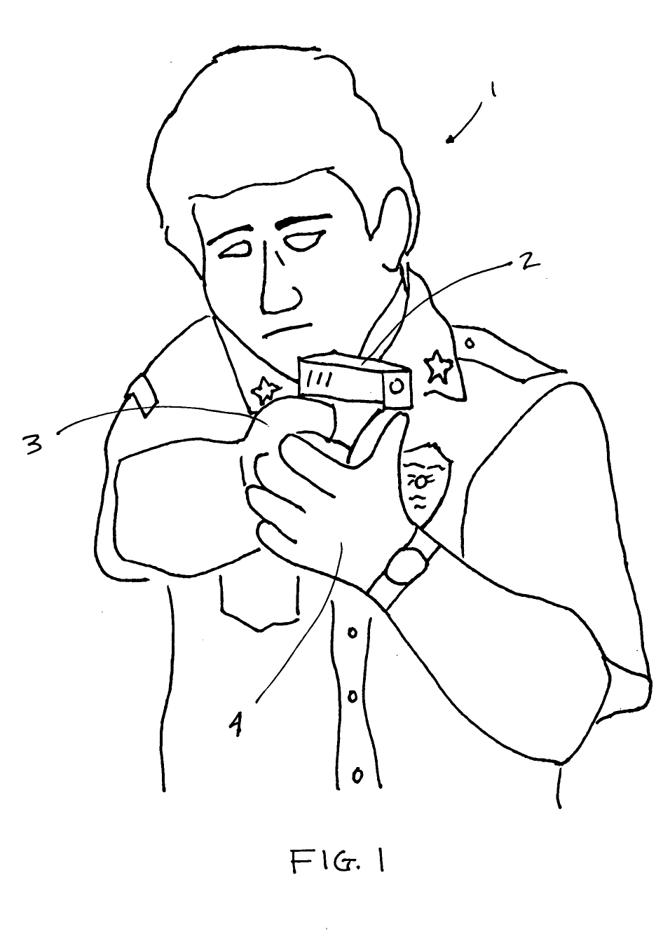

### DETAILED DESCRIPTION OF THE INVENTION

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a”, “an,” and “the” includes plural reference, the meaning of “in” includes “in” and “on.”

This invention includes a handheld tool, like a firearm or flashlight for example, having a wireless, electronic switch disposed therein. When a user, like a policeman for instance, is using the tool, the user may press a switch on the tool. When the switch is pressed, a radio frequency signal is emitted from the tool. The signal is capable of actuating at least a microphone on an external two-way communication device, like a phone or two-way radio. As such, when the user presses the mechanical switch, the electronic circuitry causes the actuation of the microphone on the radio, thereby allowing the user to talk to another party without having to manually key the radio.

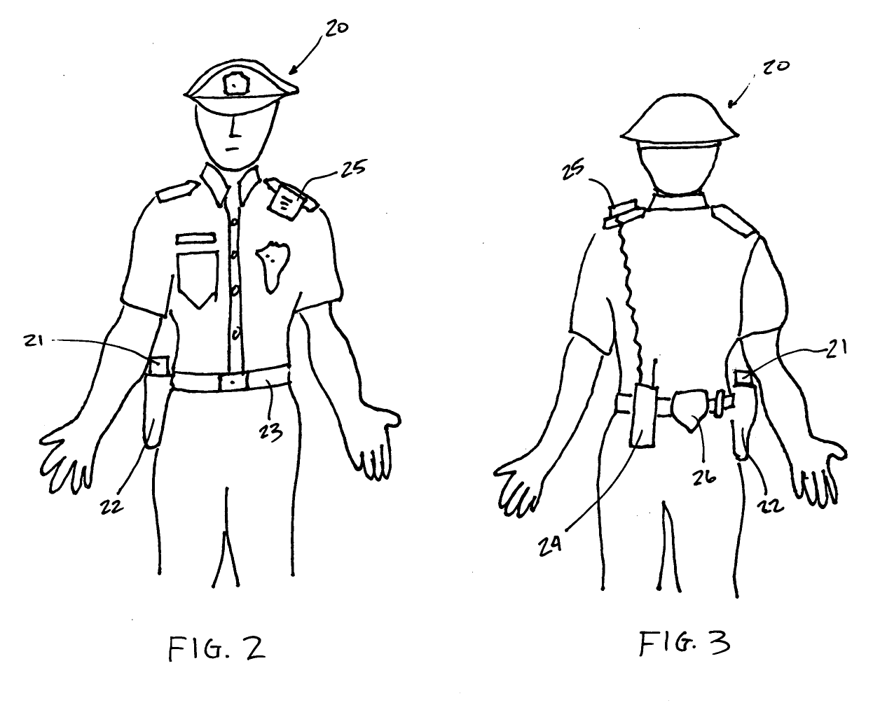

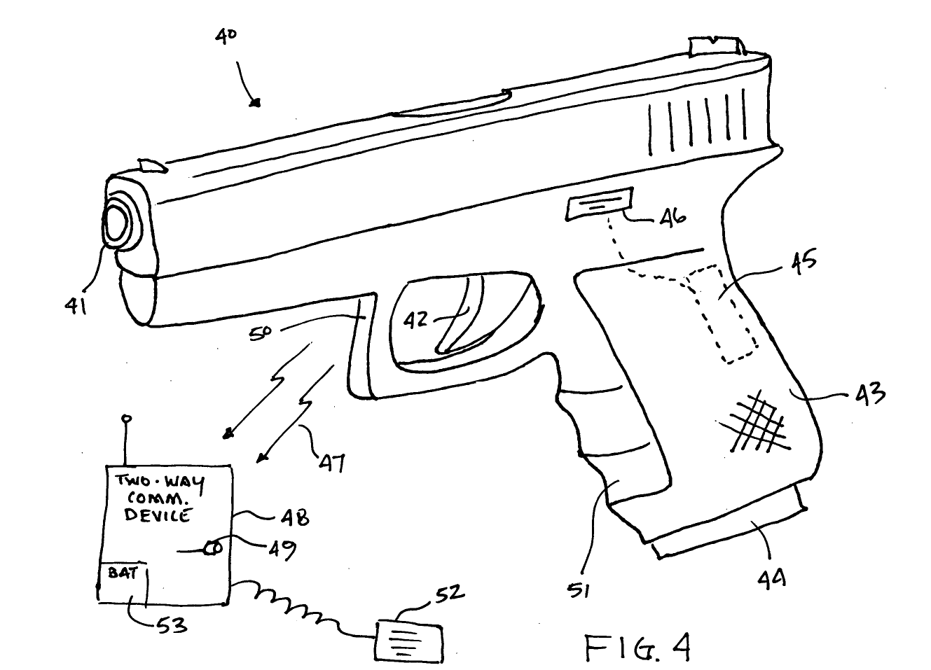

Turning now to FIGS. 2 and 3, illustrated therein are the front and rear views of a police officer wearing standard-issue equipment. The officer 20 is wearing a belt 23, to which his equipment is tethered. The officer 20 has a gun or firearm 21, placed in a holster 22 that is coupled to the belt 23. The officer 20 also has handcuffs 26 and a two-way radio 24. Other equipment, including a baton, pepper spray, extra ammunition and the like may also be coupled to the belt.

The officer 20 communicates with the precinct and other officers through his two-way radio 24. This can be done in a few different ways. First, the officer 20 may decouple the radio 24 from the belt 23, raise the radio 24 towards his mouth and ear, push the talk button on the radio 24 and talk. This is the standard operating mode.

The more popular way for policemen to communicate is via the wired, shoulder mounted audio device 25 clipped to the officer's shoulder. This device 25 generally includes a speaker and microphone, as well as a talk button, and is affectionately referred to as a “potato”. The device 25 may additionally include volume controls.

When using the shoulder mounted audio device 25, rather than having to disconnect the radio 24 from the belt 23, thereby rendering at least one hand unavailable, the officer 20 simply presses the button on the shoulder mounted audio device 25, and talks. If the officer 20 is suddenly called into action, he simply releases the button and starts to work. There is no need to re-couple devices to his personage. Nonetheless, the use of a shoulder mounted audio device 25 still requires a hand for actuation. There are no hands available when the officer's weapon 21 is drawn from the holster 22.

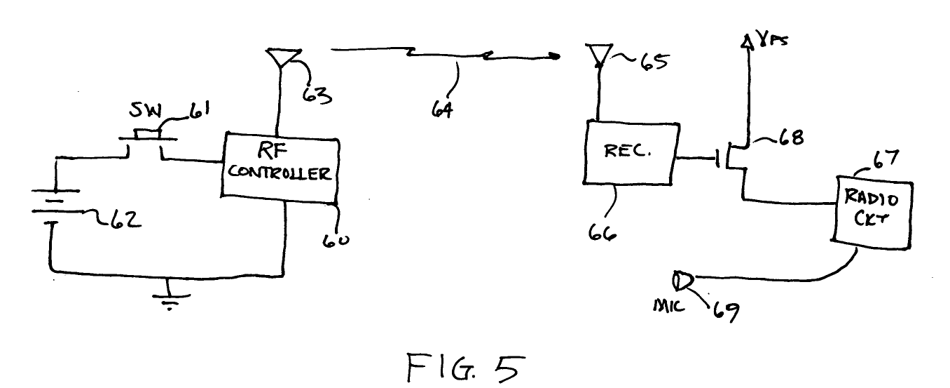

Turning now to FIG. 4, illustrated therein is a hand tool, exemplified here as a handgun 40, in accordance with the invention. The handgun 40 includes a push to talk switch 46 and electronic circuitry 45 capable of emitting an electromagnetic signal 47 when the push to talk switch 46 is actuated. The electromagnetic signal 47 is capable of actuating at least the microphone 49 of the two-way communications device 48. This handgun 40 thus allows an officer to actuate either a two-way radio or shoulder mounted audio device 52 without taking his hands off the handgun 40.

The handgun 40 has standard firearm components, including a barrel 41, trigger 42, handle grip 43 and ammunition clip 44. In this embodiment, the push to talk switch 46 is disposed on the left side of the handgun 40, so as to be easily pressed by the thumb of a right handed shooter. It will be clear to those of ordinary skill in the art, having the benefit of this disclosure, that the push to talk switch could be disposed in other places. Examples include on the right side for a left-handed shooter, on the front of the trigger guard 50, or on the finger ridges 51 of the handle grip 43.

As noted above, when the mechanical portion of the push to talk switch 46 is pressed, electronic circuitry disposed within the firearm 40 causes a radio frequency, electromagnetic signal 47 to be emitted from the hand gun 40. As used herein “mechanical switch” includes any switch that is capable of manual actuation by a user, including, for example, motionless switches like electrostatic, infrared, or temperature sensing switches. The signal 47 has a frequency and amplitude signature capable of actuating the microphone 49 and/or transmission circuitry of an external, two way communication device 48. Where the two-way communication device 48 is a radio having a shoulder mounted audio device 52 attached, an officer simply presses the push to talk switch 46 and talks into the shoulder mounted audio device 52, without the need of taking his hands off the handgun 40.

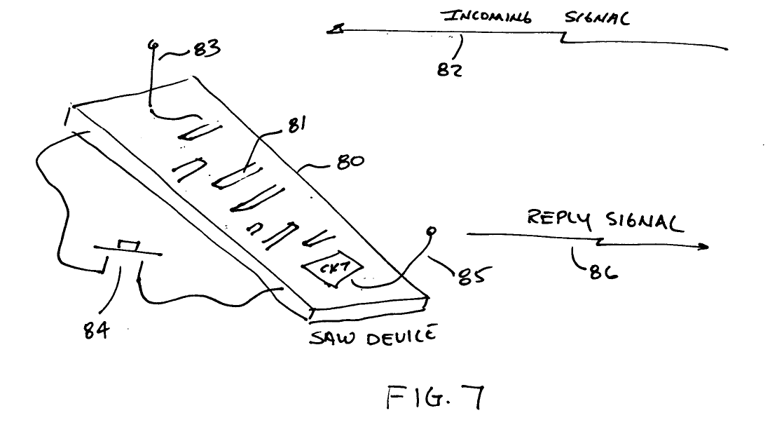

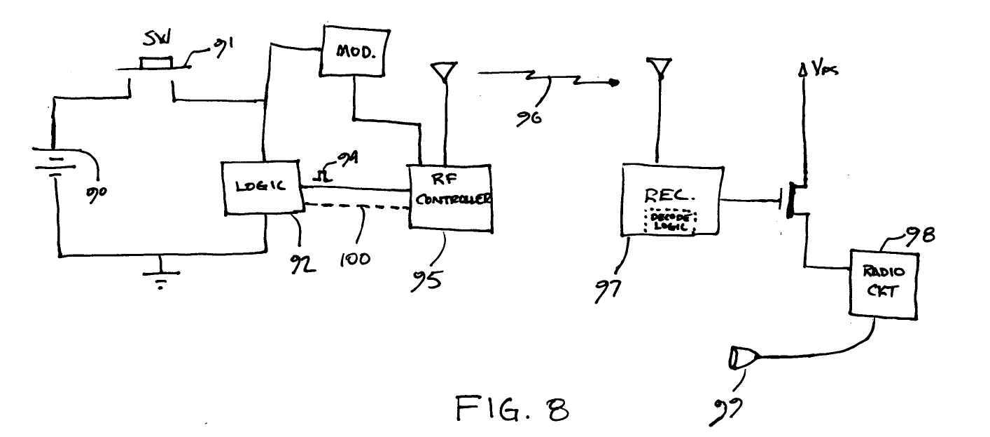

The circuitry of the wireless, push to talk switch offers many advantages over the prior art. First, the circuitry associated with the push to talk switch is far smaller in size than that of a complete radio. When the push to talk circuitry is embedded in the handle grip 43 of the handgun 40, far less ammunition storage space is sacrificed. Second, as will be seen in FIGS. 6 and 7, the wireless push to talk switch may be implemented without a battery, thereby eliminating the need to change or recharge the handgun 40. Third, the battery 53 used for communication transmission is disposed in the two-way communication device 48, which is generally coupled to a belt. Consequently, this battery 53 can be much larger than anything that could be embedded in the handgun 40, thereby greatly extending both the range and talk time of the overall system. Fourth, the microphone, being disposed in either the two-way communication device 48 or shoulder mounted audio device 52 is several feet from the handgun 40 when in use. Thus, the explosive acoustic energy and thermal energy dissipate per the distance squared, thereby improving both the reliability and audio clarity of the microphone.

Note that in addition to the handgun mentioned above, many police situations (and even more military situations) require the user to use a two-handed weapon like a rifle or rocket launcher. This invention allows users in those situations to talk without taking their hands off of such a weapon.

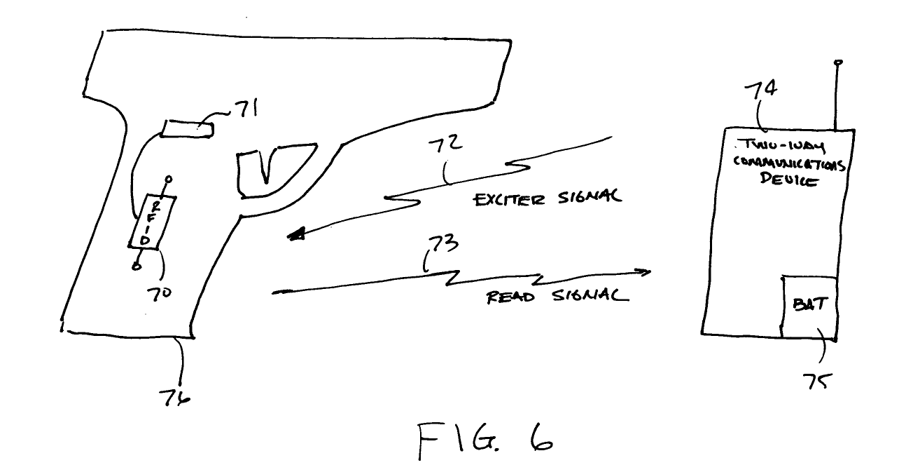

Turning now to FIG. 5, illustrated therein is one embodiment of a wireless, push to talk switch in accordance with the invention. The push to talk switch includes a transceiver chip 60, a transmission antenna 63, a mechanical switch 61 and a battery 62. The transceiver chip 60 may be as simple as an oscillator that is actuated when the mechanical switch 61 closes to complete the circuit. Another suitable transceiver chip would be a Bluetooth™ module like the BGB101 TrueBlue™ Bluetooth module manufactured by Philips. Using the Bluetooth option, the transceiver chip may communicate information to the two-way communication device via the Bluetooth, near-field protocol. Other radio frequency transmitter devices may be substituted as well.

As stated above, when the switch 61 is pressed, the transmission antenna emits a radio frequency signal 64 capable of actuating at least the microphone 69 of a two-way communications device. The two-way communications device, which may be a two-way radio, mobile telephone or other communications device, receives the radio frequency signal via an antenna 65 and receiving circuitry. Upon receipt of this signal 65, the receiving circuit 66 actuates the microphone 69 and associated circuitry 67, so that the communications device may begin transmitting. A transistor 68 is shown here as an illustrative means of actuating the microphone.

Note that it is desirable to keep the push to talk switch and associated circuitry in the hand tool as small as possible, so as to leave the original design of the hand tool undisturbed. It is also desirable to make the battery 62 in the hand tool last as long as possible to avoid the necessity of constantly replacing or recharging the battery 62. As such, in another preferred embodiment, rather than transmitting the radio frequency signal 64 continuously when the button 61 is pressed, an “on” signal is transmitted when the button 61 is pressed, and an “off” signal is transmitted when the button 61 is released. Such an alternate embodiment is illustrated in FIG. 8.

Turning now to FIG. 8, illustrated therein is a push to talk circuit designed especially for conserving energy in the battery 90 in the hand tool. This circuit reduces the amount of energy sourced from the battery 90 by transmitting an “on” signal and an “off” signal depending upon the actuation of the switch 91.

When the switch 91 is pressed, logic circuitry 92 generates, a pulse signal 94, which is sent to the RF controller 95. Simultaneously, a modulator 93 detects the state of the switch 91 (i.e. open or closed). When the switch 91 is closed, the modulator 93 sends the appropriate modulation signal to the RF controller 95, thereby enabling a brief “on” signal to be emitted as the RF signal 96. Similarly, when the switch 91 is open, e.g. when the switch 91 is released, the modulator 93 sends the appropriate modulation signal to the RF controller 95, thereby enabling a brief “off” signal to be emitted. (A brief signal is a signal of less than one second, and is generally on the order of a few milliseconds, and can even be of the order of a few microseconds.) The radio circuit includes a receiving circuit 97 that includes decode logic capable of interpreting the “on” and “off” signals and actuating the radio circuitry and microphone accordingly.

Energy consumption of the push to talk transmitting device is significantly reduced by the circuit of FIG. 8. As illustrated, when switch 91 is actuated, a short message is sent to the receiving device 97 telling the microphone 99 to “turn on”. When the switch 97 is subsequently released, a short and differently coded message is sent to the receiving device 99 telling the microphone to “turn off”.

The microphone control circuitry (not shown) may include a memory circuit that retains the state of the last transmission command. The memory command state could then be retained until modified either by a new transmission, or by input from a valid alternative source, such as a push to talk button on either the radio or shoulder mounted audio device. The resultant duty cycle of switch command transmissions can be very small compared to the actual talk time of the microphone. For example, a one-millisecond transmission may turn the microphone on for a hypothetical five-second voice radio transmission; and a subsequent one-millisecond transmission may turn the microphone off again. The time duty of the transmission energy is then only 0.04 percent. This strategy is advantageous in reducing the average energy consumption of the push to talk transmitting device, and thereby reducing the size of the battery or other energy source supplying power for the push to talk transmission. The typical user's averaged duty cycle generally is such that even a very small battery (such as a watch or hearing aid style battery) may last for months or even years of normal service.

Referring again to FIG. 8, it may also be advantageous to include fuel gauging information in the logic circuit 92. For example, if the application in which the invention is being used is a police officer's handgun, reliability if of paramount importance. For this reason, it may be desirable to alert the officer when the battery 90 has reached a predetermined threshold, like 30% of capacity. As such, the logic circuitry may also transmit a fuel gauge signal 100 that can be transmitted to the radio to alert the user when the battery 90 has reached a critical threshold. This warning may appear on the radio display, or may be relayed automatically by the radio as a maintenance warning to a central dispatch center. In either case, if a warning is detected by either a user or a dispatch center, steps could be taken to replace or recharge the battery long before the battery became fully discharged and therefore unserviceable.

Turning now to FIG. 6, illustrated therein is an alternate embodiment of a wireless, electronic switch that serves as the push to talk switch. In this embodiment, the switch is a Radio Frequency Identification (RFID) tag having programmable state information, as taught in commonly assigned U.S. Pat. No. 6,496,112 B 1, entitled “Radio Frequency Identification Tag with a Programmable Circuit State”, issued to Vega, which is incorporated herein by reference for all purposes.

In this embodiment the RFID tag 70 is essentially a passive device until an exciter signal 72 is received. The exciter signal 72, emitted for example by an electrostatic exciter embedded in the two-way communication device 74, causes the RFID tag 70 to become energized. The RFID tag 70 then transmits a read signal 73 back to the two-way communication device 74 indicating the state of the switch 71. The read signal 73 includes a carrier signal that is based upon the tag state. A reader in the communication device detects the carrier signal and thus the stored tag information.

The advantages of the embodiment of FIG. 6 include the fact that no battery is needed in the hand tool 76. All of the energy is supplied by the battery 75 coupled to the two way communication device 74. This allows for even more storage space in the hand tool 76. Where the user does not want the communication device 74 to interrogate the hand tool 76 exciter signals 72 continually, an exciter switch may be used. For example, where the hand tool 76 is a firearm, a magnetic or mechanical switch may be added to the holster such that the exciter signal 72 is only sent when the tool 76 is in use.

Turning now to FIG. 7, illustrated therein is an alternate form of the push to talk switch. In this embodiment, the push to talk switch is a surface acoustic wave (SAW) device 80. When a radio frequency, interrogation signal 82 is received by an antenna 83, the SAW device converts that wave 82 into an acoustic wave. This acoustic wave propagates across the substrate of the device through a set of fingers that cause the acoustic wave to take on a particular characteristic. This characteristic can be further modified by the state of the switch 84. The final acoustic wave is the converted back into an electromagnetic wave and transmitted from a transceiver 85 back to as a reply signal 86.

While the preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims. For example, while one exemplary hand tool illustrated herein is a handgun, it will be clear to those of ordinary skill in the art, having the benefit of this disclosure, that other tools could equally be fitted with the wireless, push to talk switch. These include power tools, flashlights, batons, hammers and saws.

What is claimed is:

1. A handheld tool comprising a wireless, electronic switch, wherein when the wireless, electronic switch is actuated, a radio frequency signal is emitted from the handheld tool, wherein the radio frequency signal is capable of actuating at least the microphone of an external, two-way communications device.

2. The handheld tool of claim 1, wherein the wireless, electronic switch comprises a push to talk button, further wherein the two-way communications device is selected from the group consisting of cellular telephones and two-way radios.

3. The handheld tool of claim 1, wherein the wireless, electronic switch comprises a manual switch, and an RF transmitter.

4. The handheld tool of claim 3, wherein the radio frequency signal is selected from the group of signals consisting of an on signal and an off signal.

5. The handheld tool of claim 4, wherein the radio frequency signal has a duration of less than 1 second.

6. The handheld tool of claim 1, wherein the wireless switch comprises a circuit that transmits the state of the wireless switch upon interrogation by an external device.

7. The handheld tool of claim 6, wherein the circuit that transmits the state of the wireless switch upon interrogation by an external device is selected from the group consisting of RFID tags and surface acoustic wave devices.

8. The handheld tool of claim 5 or 6, wherein the handheld device is selected from the group consisting of firearms, power tools, flashlights, batons, hammers, and saws.

9. The handheld tool of claim 8, wherein the wireless switch is disposed in a handle of the handheld tool.

10. A handgun, comprising:
a. a barrel;
b. a chamber for carrying ammunition;
c. a trigger;
d. a handle grip; and
e. an wireless, push to talk switch;
wherein when the wireless, push to talk switch is actuated, an electromagnetic signal is emitted from the handgun, the electromagnetic signal being capable of actuating at least the microphone of a remote two-way communication device.

11. The device of claim 10, wherein the wireless, push to talk switch comprises:
a. a transceiver chip;
b. a transmission antenna;
c. a mechanical switch; and
d. a battery.

12. The device of claim 11, wherein the wireless, push to talk switch comprises electronic circuitry that responds to interrogation signals from an external device, wherein when the electronic circuitry receives an interrogation signal from the external device, the electronic circuitry causes the electromagnetic signal emitted from the handgun to be indicative of the state of the mechanical switch.

13. The device of claim 12, wherein the external device is selected from two-way radios and phones.

14. The device of 13, wherein the interrogation signal transmission is initiated when the handgun is drawn from a holster.

15. The device of claim 10, wherein the barrel comprises an antenna for transmitting the electromagnetic signal.

16. The device of claim 10, wherein the wireless, push to talk switch is disposed in the handle grip.

17. A system, the system comprising:
a. a hand tool, comprising:
i. a mechanical switch; and
ii. a short-range, wireless transmission circuit;
wherein the short-range, wireless transmission circuit is capable of transmitting the state of the mechanical switch; and
b. a two-way communications device;
wherein when the mechanical switch is actuated, the short-range, wireless transmission circuit causes at least a microphone of the two-way communications device to actuate, further causing the two-way communications device to transmit.

18. The system of claim 17, wherein the hand tool is selected from the group consisting of firearms, power tools, flashlights, batons, hammers, and saws.

19. The system of claim 18, wherein the two-way communications device is selected from the group consisting of two-way radios and mobile telephones.

20. The system of claim 19, wherein the two-way communications device comprises a two-way radio having a shoulder mounted audio device.

21. The system of claim 19, wherein the two-way communications device comprises a warning alarm to indicate that a battery coupled to the short-range, wireless transmission circuit has reached a critical threshold.
